(19) United States
(12) Patent Application Publication
(10) Pub. No.: US 2017/0058818 A1
(43) Pub. Date: Mar. 2, 2017

(54) AIR/FUEL MIXTURE CONTROL SYSTEM FOR INTERNAL COMBUSTION ENGINES

(71) Applicant: John Peter Halsmer, Bloomfield Hills, MI (US)

(72) Inventor: John Peter Halsmer, Bloomfield Hills, MI (US)

(21) Appl. No.: 14/834,058

(22) Filed: Aug. 24, 2015

(51) Int. Cl. F02D 41/30; F02M 69/14; F02M 69/18

(52) U.S. Cl. CPC F02D 41/3082; F02M 69/18; F02M 69/147

(57) ABSTRACT

A control system for automatically adjusting air/fuel mixture in an internal combustion engine having a mechanical fuel injector system. The automatic air/fuel mixture control system has an electronic control unit which controls the quantity of fuel provided to the combustion chamber in response to sensor inputs in accordance with desired parameters.

### FIELD OF THE INVENTION

The present invention relates to an air/fuel mixture control system for internal combustion engines. More particularly, the present invention relates to a system which provides automatic mixture control for internal combustion engines having fixed orifice fuel injectors. The system is particularly well suited as a modification to an existing carbureted or mechanically fuel injected aircraft engine to provide automatic air/fuel mixture control for the engine.

### BACKGROUND OF THE INVENTION

Internal combustion engines are used to power many different kinds of vehicles including aircraft but engines in aircraft present some unique design challenges. For example, aircraft often fly at different altitudes and hence aircraft engines encounter substantially different induction air pressures which requires means for adjusting the ratio of air to fuel in the engine's cylinders. Although there have been many improvements relating to the adjustment of the air/fuel ratio in aircraft, such as the development of precise engine monitoring systems, there remains room for further improvements, particularly with respect to setting a precise air/fuel mixture for the conditions being encountered by the engine.

Of course, it is important that aircraft engines be reliable, hence, aircraft engines are designed with fail-safe features such as dual ignition systems, electric fuel pumps to back up mechanical fuel pumps, alternate air sources, and “fail safe” systems. Fuel injection systems have replace carbureted fuel systems and carbureted engines can be modified to have fuel injected systems such as is disclosed in my earlier U.S. Pat. No. 7,290,531 Nov. 6, 2007 for “Integrated Fuel Supply System for Internal Combustion Engine” which is specifically incorporated by reference herein. However, although many piston engines for aircraft have fuel injection systems, most use mechanical fuel injectors rather than electronic fuel injectors because of cost and reliability concerns. Mechanical fuel injectors are fixed orifice designs which are reliable but provide constant flow for a given fuel pressure and do not offer automatic control of the air/fuel mixture. Electronic fuel injectors offer a means for automating air/fuel mixture control but are more expensive and require circuitry which can fail or be subject to interference leading to engine failure.

There are many existing aircraft engines which would benefit if they could be modified to have precise automatic air/fuel mixture control at a reasonable cost. Most aircraft engines operate over a wide range of atmospheric conditions which affect air density which in turn affects the ration of air to fuel going into the cylinders . During a typical flight using a typical aircraft engine, the air/fuel mixture control must be manually adjusted by the pilot several times to compensate for different air densities as well as for different operating conditions such as different altitudes or power settings. For example, take-off might be carried out using a high power throttle setting and a full rich mixture to provide power and cooling, then the power is reduced and the mixture is “leaned” slightly for climbing to a desired altitude and then the power is further reduced and the mixture is further “leaned” for cruising. Subsequent changes in altitude, power settings, etc. will require further adjustments to the mixture, either enriching or leaning the mixture. Some aircraft have engine monitoring systems to assist the pilot but the pilot must manually adjust the mixture which imposes an additional workload on the pilot and can be a distraction. Often mixture adjustments are made late and are not very precise.

A few modern aircraft have FADEC systems which accomplish the leaning procedure automatically. A FADEC system is a full authority digital electronics control consisting of a digital computer and related accessories for controlling air/fuel mixture and other aircraft engine parameters. However, FADEC systems are generally too expensive for use to retrofit existing engines and involve the use of electronic fuel injectors. It would be highly desirable to have an automatic system which would provide full authority digital electronics control of the air fuel mixture of a conventional aircraft engine which has mechanical fuel injectors.

Furthermore, there remains a need for an improved system for modification of existing aircraft engines so that they can enjoy the advantages of precise automatic adjustment of air/fuel mixture and the associated improved performance, efficiency and reliability. There also remains a need for an automatic air/fuel control system which has a “fail safe” mode and goes to an enriched mixture using the preexisting mechanical fuel system with fixed orifice fuel injector nozzles if there is a system failure so that the engine can continue to operate.

Accordingly, the present invention is directed to a system which can be adapted to a conventional certified or experimental aircraft engine designs to improve their performance and efficiency. The system of this invention provides precise automatic mixture control which reduces pilot work load, making “real time” instantly proper mixture in response to changing conditions such as changing air density and/or power settings. By ensuring that the engine runs at the proper mixture, the present system improves the durability of engines which leads to longer times between overhauls and reduced costs. The system avoids problems caused by the pilot forgetting to adjust the mixture which can lead to spark plug fouling, fuel exhaustion or engine damage due to detonation or overheating. An engine employing the system of this invention will run more smoothly, have improved efficiency and provide real time precise mixture adjustment automatically. And if the automatic air/fuel mixture control fails for some reason, the system will go to an enriched mixture allowing the pilot to manually lean the mixture if necessary.

Further understanding of the present invention will be had from the following description and claims taken in conjunction with the accompanying drawings.

### BRIEF DESCRIPTION OF THE DRAWINGS

FIG. 1 is a somewhat schematic view of a preferred embodiment of a system of the present invention using an electronic fuel control unit to control a fuel bleed down valve for a flow divider;

FIG. 2 is a somewhat schematic view of an alternative preferred embodiment of a system of the present invention using an electronic fuel control unit to control individual fuel bleed down valves for each injector;

FIG. 3 is a somewhat schematic view of another alternative preferred embodiment of a system of the present invention using an electronic fuel control unit to control a vacuum bleed valve which is in fluid communication with air sensing vacuum chambers of a throttle body;

FIG. 4 is a somewhat schematic view of another alternative preferred embodiment of the present invention using an electronic fuel control unit to control a pulse width modulated electric fuel pump to enable mixture control through fuel pressure control;

FIG. 5 is a somewhat schematic view of yet another alternative preferred embodiment of the present invention using an electronic fuel control unit to control a fuel flow control module connected to a flow divider; and

FIG. 6 is a somewhat schematic view of a preferred alternate embodiment of the present invention using an electronic fuel control unit to control a pulse width modulated electric fuel pump which meters fuel to an injector positioned upstream of a throttle plate.

### SUMMARY OF THE INVENTION

A system of the present invention automatically adjusts the air/fuel mixture in the combustion chamber or chambers of an internal combustion engine having a fixed orifice fuel injector system. The system has an electronic control unit (ECU) which is programmed to automatically adjust the air/fuel mixture in each combustion chamber by controlling the amount of fuel provided to each fixed orifice fuel injector in response to sensor input in accordance with desired parameters. The system adjusts the mixture from a fuel mixture system which is set to default to run relatively rich so that if there is a failure of the automatic electronic system, there is a virtually seamless ability to revert back to the pre-existing mechanical system. The system is particularly well-suited to be retrofit onto existing aircraft engines which have mechanical fuel injectors or have carburetors but can be modified to have mechanical fuel injectors.

### DESCRIPTION OF THE INVENTION

Broadly speaking, the present invention relates to a method and system for controlling the air/fuel mixture provided to an internal combustion engine having fixed orifice fuel injectors, commonly referred to as mechanical fuel injectors. The system is also useful for engines which have carburetors but can be modified to have mechanical fuel injectors for use in accordance with the present invention. The method and system of the present invention uses an electronic fuel control unit to automatically and precisely lean the air/fuel mixture in response to inputs from various sensors and in accordance with desired parameters by reducing the quantity of fuel fed into mechanical type fuel injectors in the cylinders of an internal combustion engine.

The system of the present invention is particularly well adapted to retrofit aircraft engines which have mechanical fuel injectors or can be modified to have mechanical fuel injectors. Mechanical fuel injectors have constant flow nozzles with fixed orifices and are usually located in the intake manifold near the intake valve of each cylinder. The air/fuel ratio of aircraft engines using mechanical fuel injectors is traditionally accomplished by the pilot manually adjusting a “mixture” control to reduce fuel pressure at the input side of each fixed orifice injector to thereby reduce the amount of fuel supplied to each cylinder at a given throttle setting. Traditional mixture adjustments are often not very timely or precise. Some aircraft engines also have a mechanical arrangement in the throttle body which makes approximate adjustments to the mixture to compensate for altitude changes. However, further manual adjustment of the mixture is required for precise mixture adjustment.

In accordance with the present invention, an electronic, automatic mixture adjustment system is provided for fuel injected engines having mechanical fuel injectors. The air/fuel mixture in each cylinder is adjusted by an electronic control unit which reduces the quantity of fuel supplied to each cylinder in response to sensor input. The present invention uses an electronic control unit or ECU to provide the advantages of a FADEC system to aircraft engines with fixed orifice fuel injectors. Furthermore, the present invention provides a system which is a “fail safe” in that it reverts back to the original mechanical fuel supply system if the electronic control system should fail.

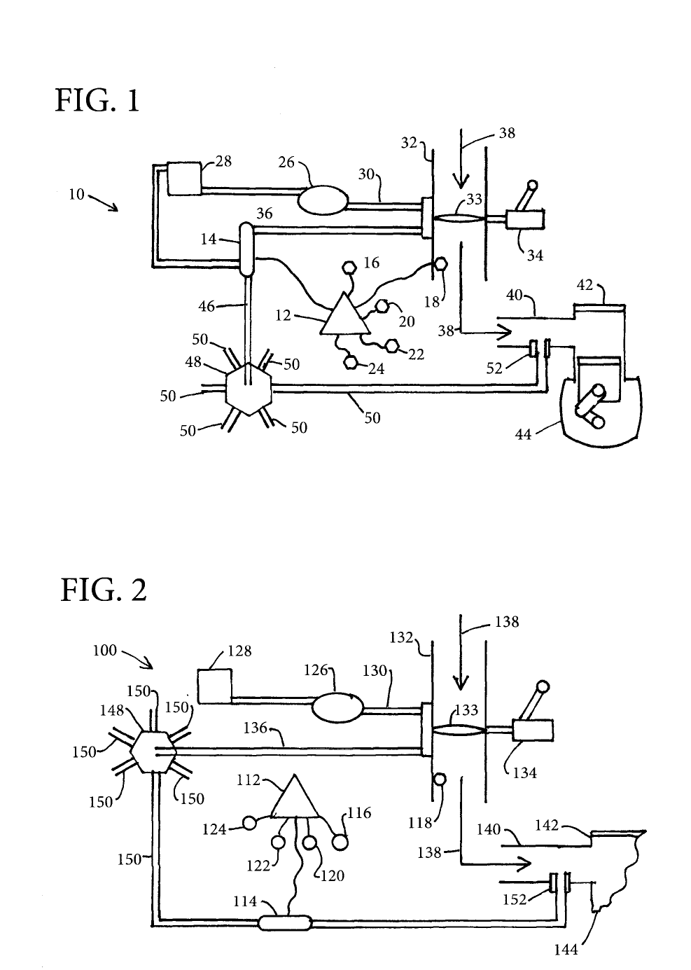

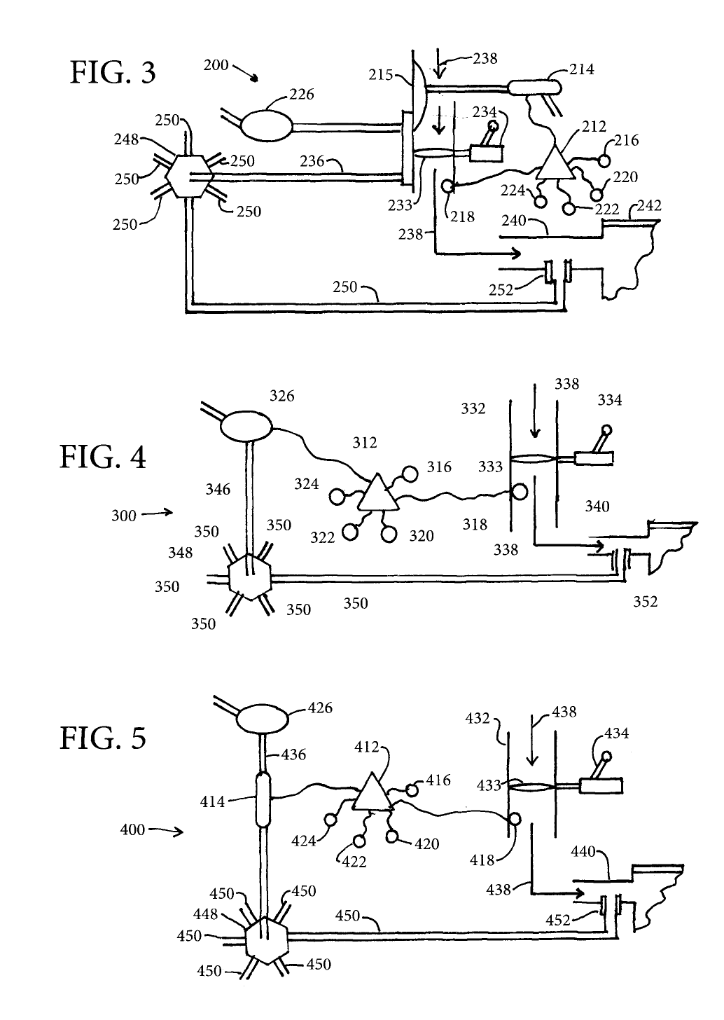

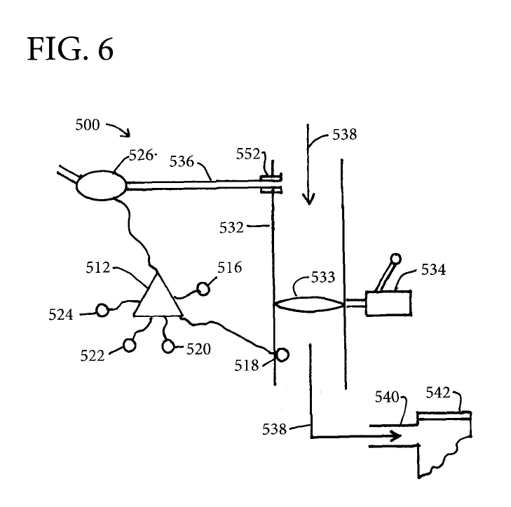

The electronic control unit or ECU of the present system is operatively connected to function to reduce the fuel supply to each cylinder by reducing the fuel pressure to each constant orifice injector. The ECU includes a microprocessor which is programmed to compute the desired air/fuel mixture for the particular operating conditions of the engine. The operating conditions are signaled to the ECU by inputs from various sensors. If the electronic fuel control unit fails then the fuel pressure is not reduced and the engine is set to run rich under the existing mechanic al fuel supply system. The ECU reduces fuel supply by either:
bleeding down the metered fuel pressure before a flow divider to lean the mixture (see FIG. 1);
bleeding down the metered fuel pressure after the flow divider, to lean the mixture for each individual cylinder (see FIG. 2);
bleeding down the air vacuum sensed by an altitude compensating throttle body to lean the mixture (see FIG. 3);
controlling fuel pressure to a flow divider or fuel injector of a fuel injection system by controlling the pressure output of a pulse width modulated electric fuel pump (see FIGS. 4 and 6); or
controlling the input to the fuel injector(s) or flow divider by using a mechanical fuel pump with a fuel flow control component inserted between the fuel pump and the injectors or flow divider (see FIG. 5).

Now referring to FIG. 1, a preferred embodiment of the present invention is shown and indicated generally by the numeral 10. System 10 has an electronic fuel control unit (ECU) 12 connected to and controlling fuel bleed valve 14. ECU 12 is electrically connected and to several sensors: rpm sensor 16, manifold pressure sensor 18, outside air temperature sensor 20, atmospheric pressure sensor 22, and exhaust gas temperature (EGT) sensor 24. Preferably multiple EGT sensors are connected to ECU 12: one EGT for each cylinder of an associated piston engine. Of course, it is contemplated that other suitable sensors may be connected to provide input data to ECU 12.

Fuel pump 26 is in fluid communication with fuel tank 28 and pumps fuel through fuel line 30 to throttle body 32. Throttle 34 is connected to throttle body 32 having throttle plate 33 and which meters fuel in a conventional manner in response to throttle position to provide metered fuel through metered fuel line 36 to fuel pressure bleed valve 14. As is conventional in the art, throttle body 32 also controls the amount of intake air, indicated by arrow 38, provided to intake manifold 40 which provides air/fuel mixture to cylinder 42 of engine 44. . It will be appreciated by those skilled in the art that, while only one cylinder 42 is shown in the Figure, it is contemplated that multiple cylinders 42 of engine 44 will be connected to intake manifold 40 as is conventional in the art.

Throttle body 32 controls manifold pressure in intake manifold 40 and provides metered fuel through fuel line 36 at a pressure to provide metered fuel at a “full rich” mixture. ECU 12 controls fuel bleed valve 14 to reduce the pressure and thereby the quantity of fuel flowing through fuel line 46 to flow divider 48 and hence to adjust the amount of fuel flowing through a plurality of injector lines 50, each of which is in fluid communication with a fuel injector 52 which injects fuel into each cylinder 42 in a conventional manner. Fuel injectors 52 are generally located near an intake valve of an associated cylinder 42. System 10 is shown as having six injectors for six cylinders but the exact number of injectors and cylinders may vary within the scope of the present invention.

It is intended that throttle body 32 be set to provide metered fuel at a pressure that would provide a “rich” mixture into cylinders 42 through injectors 52 if fuel pressure bleed valve 14 did not reduce the quantity of fuel going to the fuel injectors 52 to provide a leaner air/fuel mixture to cylinder 42. Fuel bleed valve 14 functions to either not to reduce or to reduce the fuel pressure going to flow divider 48 and hence to injectors 52. Thus, injectors 52 run at full rich or are leaned from full rich mixtures as controlled by ECU 12 controlling fuel bleed valve 14. While operating in automatic mode, throttle body 32 is always run or set to a relatively rich configuration. System 10 adjusts fuel by only reducing the amount of fuel so that if system 10 fails, fuel supplied to cylinders 42 provides a “rich” mixture.

Now referring to FIG. 2, an alternative preferred embodiment of the present invention is shown and indicated generally by the numeral 100. System 100 is generally analogous to system 10 but individually controls the fuel flow to each injector at the injector down steam of the flow divider. Thus, system 100 has an electronic fuel control unit (ECU) 112 connected to fuel bleed valves 114 and to several sensors: rpm sensor 116, manifold pressure sensor 118, outside air temperature sensor 120, atmospheric pressure sensor 122, and exhaust gas temperature sensor (EGT) 124. Of course, additional sensors may be used such as an EGT for each cylinder. Fuel pump 126 draws fuel from fuel tank 128 to pump fuel under pressure through fuel line 130 to throttle body 132 which has throttle plate 133 and which is controlled by throttle 134 and through which intake air 138 is provided to intake manifold 140 of engine 144. Metered fuel is provided through fuel line 136 to flow divider 148 which evenly divides fuel into a plurality fuel injector lines 150, one line for each cylinder 142. Each injector line 150 provides fuel to a fuel bleed valve 114 which is controlled by ECU 112 to reduce or not reduce the pressure (i.e., the quantity) of fuel flowing to each injector 152 to thereby adjust the amount of fuel flowing into intake manifold 140 for each cylinder 142. Throttle body 132 controls the amount of air 138 provided to intake manifold 140 and is manually set by throttle 134. Throttle body 138 is always run or set to a full fuel at a full rich configuration for whatever power setting is selected by throttle 134.

Now referring to FIG. 3, another alternative preferred embodiment of the present invention is shown and indicated generally by the numeral 200. System 200 includes a throttle body which has an air density compensator. Thus, system 200 has an electronic fuel control unit (ECU) 212 connected to several sensors: rpm sensor 216, manifold pressure sensor 218, outside air temperature sensor 220, atmospheric pressure sensor 222, and exhaust gas temperature sensor 224 (again, additional sensors can also be used). ECU 212 is also connected to, and controls vacuum bleed valve 214 which is in fluid communication with throttle body low pressure signal 215 that determines the metered fuel pressure of throttle body 232 to bleed vacuum therefrom to provide more accurate adjustment to the fuel air mixture by further controlling fuel pressure in metered fuel line 236. Fuel pump 226 draws fuel from fuel tank 228 to pump fuel under pressure to throttle body 232 which has throttle plate 233 and which is controlled, i.e. the power is set, by throttle 234 and through which intake air 238 is provided to intake manifold 240 of the engine (not shown in the Figure but analagous to engines 44 and 144. Metered fuel is provided by throttle body 232 through fuel line 236 to fuel divider 248. ECU 212 controls vacuum bleed valve 214 which automatically adjusts air density compensator 215 to further finely adjust metered fuel pressure in fuel line 236 to fuel divider 248 and thence to each injector line 250 thereby adjusting the amount of fuel flowing through injectors 252. Throttle body 232 controls the amount of air 238 provided to the intake manifold and the amount of fuel provided to the flow divider. Throttle body 232 is always run or set to a full rich configuration except as leaned by air density compensator 215 which is further controlled by vacuum bleed valve 214.

Now referring to FIG. 4, yet another alternative preferred embodiment of a system of the present invention is shown and indicated generally by the numeral 300. System 300 has an electronic fuel control unit (ECU) connected to a pulse width modulated fuel pump. Thus, fuel pump 326 draws fuel from a fuel tank (not shown in the Figure but analogous to fuel tanks 28 and 128. Fuel pump 326 is a pulse width electric fuel pump which pumps fuel under pressure through fuel line 346 to flow divider 348. System 300 has ECU 312 which is connected to several sensors: rpm sensor 316, manifold pressure sensor 318, outside air temperature sensor 320, atmospheric pressure sensor 322, and exhaust gas temperature sensor 324, and other sensors as desired such as additional EGT sensors for each cylinder. The power is set in throttle body 332 by throttle 334 and through which intake air 338 is provided past throttle plate 333 to intake manifold 340 of the engine (not shown in the Figure but analogous to engines 44 and 144).

The fuel pressure in fuel line 346 is controlled by ECU 312 which is operatively connected to electric pulse width fuel pump 326. ECU 312 controls pulse width modulated fuel pump 326 to control the fuel pressure in fuel line 336 to thereby control the amount of fuel flowing into flow divider 348 and hence to adjust the amount of fuel flowing through each fuel injector line 350 and through each fuel injector 352 into intake manifold 340 and associated cylinder 242 of the engine (not shown but analogous to engines 44 and 144). Only one injector 352 is shown in the figure but it will be appreciated by those skilled in the art that each fuel line 350 feeds an associated injector 352. The exact number of injector fuel lines and injectors is dependent upon the number of cylinders and design of the engine. The fuel line pressure is determined by ECU 212 based on rpm and manifold pressure taking into consideration outside air pressure and temperature as well as EGTs and other desired parameters. Throttle body 332 controls the amount of air 338 provided to intake manifold 340.

Now referring to FIG. 5, an alternative embodiment of the present invention is is shown and indicated generally by the numeral 400. System 400 has a mechanical fuel pump which outputs a given pressure which is then further adjusted by a fuel flow control module. Thus, system 400 has fuel pump 426 which draws fuel from a fuel tank (not shown in the Figure but analogous to fuel tanks 28 and 128). Fuel pump 426 pumps fuel through fuel line 436 into fuel flow control module 414 and thence through fuel line 446 into fuel flow divider 448. Fuel flow control module 414 can be, for example, an electrically controlled variable orifice or other electrically controlled pressure regulator. An electronic fuel control unit (ECU) 412 is connected to several sensors: rpm sensor 416, manifold pressure sensor 418, outside air temperature sensor 420, atmospheric pressure sensor 422, and exhaust gas temperature sensor 424, and other sensors as desired such as additional EGT sensors for each cylinder. Fuel pump 426 provides fuel through fuel line 436 to fuel flow control module 414 which is controlled by ECU 412 to control the fuel pressure in fuel line 446, to thereby adjust the fuel pressure in flow divider 448 and hence to adjust the amount of fuel flowing through each fuel injector line 450 into fuel injectors 452. The fuel line pressure is determined by ECU 412 based on rpm and manifold pressure taking into consideration outside air pressure and temperature as well as EGTs and other desired parameters. Throttle body 432 with throttle plate 433 controls the amount of air 438 provided to the intake manifold.

Now referring to FIG. 6, yet another alternative preferred embodiment of a system of the present invention is shown and indicated generally by the numeral 500. System 500 has an electronic fuel control unit (ECU) connected to a pulse width modulated fuel pump which meters fuel to an injector positioned upstream of the throttle plate in the throttle body. Fuel pump 526 draws fuel from a fuel tank (not shown in the Figure but analogous to fuel tanks 28 and 128. Fuel pump 526 is a pulse width electric fuel pump which pumps fuel under pressure controlled by ECU 512 through fuel line 536 to fixed orifice fuel injector 552. Injector 552 is positioned upstream of throttle plate 533 in throttle body 532. This arrangement is suitable for use with an engine which has a carburetor which, of course, is not used as a fuel source in this instance. Thus, the carburetor could be used as a back up fuel system as taught in my U.S. Pat. No. 7,290,531. ECU 312 is connected to several sensors: rpm sensor 516, manifold pressure sensor 518, outside air temperature sensor 520, atmospheric pressure sensor 522, and exhaust gas temperature sensor 524, and other sensors as desired such as additional EGT sensors for each cylinder. The power is set in throttle body 532 by throttle 534 with throttle plate 533 and through which intake air 538 is provided to intake manifold 540 of the engine. The fuel pressure in fuel line 536 is controlled by ECU 512 which is operatively connected to electric pulse width fuel pump 526 to thereby control the amount of fuel flowing into injector 552. It will be appreciated by those skilled in the art that fuel injector 552 may alternatively be located at throttle plate 533 or downstream of throttle plate 533 and that more than one injector may be employed. The fuel line pressure is determined by ECU 512 based on rpm and manifold pressure taking into consideration outside air pressure and temperature as well as EGTs and other desired parameters while throttle body 532 controls the amount of air 38 provided to intake manifold 340.

It will be appreciated by those skilled in the art that the present invention is subject to modification and variation. It is intended that such modifications and variations are considered to be within the broad scope of the invention which is intended to be limited only by the following claims. Such modifications are intended to be included herein so long as they operate in accordance with the principles of this invention.

What is claimed is:

1. An air/fuel mixture control system for an internal combustion engine having a fixed orifice fuel injector system, said mixture control system comprising an electronic control unit having a plurality of sensors and operatively connected to control pressure of fuel flowing to each said injector.

2. An air/fuel mixture control system as in claim 1, said mixture control system comprising an electronic control unit having a plurality of sensors and operatively connected to a flow control valve through which fuel flows to said injector, said electronic control unit reducing pressure of fuel flowing through said valve.

3. The air/fuel mixture control system of claim 1 wherein said system comprises a pulse width modulated fuel pump in fluid communication with said injector, said electronic control unit being operatively connected to said fuel pump to control fuel pressure ouput of said fuel pump.

4. The air/fuel mixture control system of claim 1 wherein said system comprises a fuel bleed valve in fluid communication with a fuel divider providing fuel to a plurality of fuel injectors; said fuel bleed valve being controlled by said electronic control unit to adjust fuel flow to said fuel divider.

5. The air/fuel mixture control system of claim 1 wherein said system comprises a fuel bleed valve in fluid communication between a fuel divider and each one of a plurality of fuel injectors, said fuel bleed valves being controlled by said electronic control unit to adjust fuel flow to each of said fuel injectors.

6. The air/fuel mixture control system of claim 1 wherein said system comprises a vacuum bleed valve in fluid communication between vacuum chambers in a fuel injection throttle body, said vacuum bleed valve being controlled by said electronic control unit to adjust vacuum to said throttle body to thereby adjust metered fuel flow through said throttle body to a fuel divider.

7. The air/fuel mixture control system of claim 1 wherein said engine has a throttle plate and said injector is positioned upstream of said throttle plate.

8. The air/fuel mixture control system of claim 7 wherein said engine has a carburetor.

9. A method of controlling air/fuel mixture in an internal combustion engine by installing an air/fuel mixture control system on said engine, said system having at least one fixed orifice fuel injector, and controlling fuel flowing through said injector using an electronic control unit having a plurality of sensors.

10. The method of claim 9, wherein said electronic control unit has a plurality of sensors and said system has a flow control valve through which fuel flows to said injector, said electronic control unit controlling pressure of fuel flowing through said valve.

11. The method of claim 9, wherein said system comprises a pulse width modulated fuel pump in fluid communication with said injector, said electronic control unit being operatively connected to said fuel pump to adjust air/fuel mixture by controlling fuel pressure ouput of said fuel pump.

12. The method of claim 9, wherein said air/fuel mixture control system comprises a fuel bleed valve in fluid communication with a fuel divider providing fuel to a plurality of fuel injectors; said fuel bleed valve being controlled by said electronic control unit to adjust fuel flow to said fuel divider.

13. The method of claim 9, wherein said system comprises a fuel bleed valve in fluid communication between a fuel divider and each one of a plurality of fuel injectors, said fuel bleed valves being controlled by said electronic control unit to adjust fuel flow to each of said fuel injectors.

14. The method of claim 9, wherein said system comprises a vacuum bleed valve in fluid communication between vacuum chambers in a fuel injection throttle body, said vacuum bleed valve being controlled by said electronic control unit to adjust vacuum to said throttle body to thereby adjust metered fuel flow through said throttle body to a fuel divider.

15. The method of claim 9, wherein said engine has a throttle plate and said injector is positioned upstream of said throttle plate.

16. The method of claim 15 wherein said engine has a carburetor.
